(19) United States
(12) Patent Application Publication
(10) Pub. No.: US 2023/0322229 A1
(43) Pub. Date: Oct. 12, 2023

(54) VEHICLE CONTROL DEVICE, STORAGE MEDIUM FOR STORING COMPUTER PROGRAM FOR VEHICLE CONTROL, AND METHOD FOR CONTROLLING VEHICLE

(71) Applicant: TOYOTA JIDOSHA KABUSHIKI KAISHA, Toyota-shi (JP)

(72) Inventor: Kenta KUMAZAKI, Tokyo-to (JP)

(73) Assignee: TOYOTA JIDOSHA KABUSHIKI KAISHA, Toyota-shi (JP)

(21) Appl. No.: 18/165,732

(22) Filed: Feb. 7, 2023

(30) Foreign Application Priority Data
Apr. 6, 2022 (JP) 2022-063626

(51) Int. Cl. B60W 30/18; B60W 50/10; B60W 40/04; B60W 60/00

(52) U.S. Cl. CPC B60W 30/18163; B60W 50/10; B60W 40/04; B60W 60/001

(57) ABSTRACT

A vehicle control device has a processor configured to set a reference lane change start zone on a traveling lane, determine a target lane change start zone on the traveling lane, based on the reference lane change start zone and a current correction value, count a number of requests as number of times a vehicle lane change has been requested by the driver at a different location than a start location of the target lane change start zone, and calculate a new correction value for the reference lane change start zone, based on a correction coefficient determined based on the number of requests, and distance between the start location of the target lane change start zone and request location where the vehicle lane change has been requested, wherein the next target lane change start zone is determined based on the reference lane change start zone and the new correction value.

### FIELD

The present disclosure relates to a vehicle control device, to a storage medium storing a computer program for vehicle control, and to a method for controlling a vehicle.

### BACKGROUND

An automatic control system mounted in a vehicle generates a navigation route for the vehicle based on the current location of the vehicle, the destination location of the vehicle, and a navigation map. The automatic control system estimates the current location of the vehicle using the map information and controls the vehicle to travel along the navigation route.

When the vehicle is traveling on a single traffic lane (traveling lane) on a road which has multiple lanes, for example, there are sometimes one or more traffic lanes between the traveling lane and the traffic lane that connects with a branching lane leading to the destination location. In such cases, the vehicle must make multiple lane changes from the current traveling lane in order to move to the branching road.

The automatic control system of the vehicle sets a lane change start zone for each lane adjacent to the road branching from the current traveling lane, where movement between lanes is to start by automatic control. The automatic control system sets a lane change start zone for each lane based on the location of the vehicle, the branching location where the branching road branches, and the speed of the vehicle, for example.

Incidentally, Japanese Unexamined Patent Publication No. 2020-192824 proposes a driving behavior control system that sets parameters establishing the driving behavior for an automatic driven vehicle in response to a specific driving situation, detects passenger feedback for the driving behavior resulting from the parameters and, based on the parameters that have been changed in response to the feedback, establishes driving behavior for cases in which the automatic driven vehicle subsequently encounters the specific driving situation or a driving situation similar to the specific driving situation.

### SUMMARY

When it is desired to rapidly reach a target lane, it is possible to travel faster by traveling at higher speed on the passing lane side, and therefore some drivers may request a lane change at a further location than the start location of the lane change start zone. Some drivers may also request a lane change at a location before the start location of the lane change start zone.

However, the lane change start zone is set without reflecting driver preference. While it has been previously proposed to determine driving behavior for a vehicle based on rider feedback as mentioned above, there still remains room for improvement in terms of uniformly setting lane change start zones.

It is an object of the present disclosure to provide a vehicle control device that sets lane change start zones in a manner which allows lane changes to be carried out while reflecting driver preference.

One embodiment of the invention provides a vehicle control device. The vehicle control device has a reference zone setting unit that sets a reference lane change start zone on a traveling lane, which is to be a reference zone in which a vehicle starts to move between lanes by automatic control, when movement of the vehicle from the traveling lane in which the vehicle is traveling to an adjacent lane is scheduled; a target zone determining unit that determines a target lane change start zone on the traveling lane, where the vehicle is to be controlled so that the vehicle starts to move between lanes by automatic control, based on the reference lane change start zone and a current correction value; a counting unit that counts a number of requests as a number of times a vehicle lane change has been requested by the driver at a different location than a start location of the target lane change start zone; and a correction value calculating unit that calculates a new correction value for the reference lane change start zone, based on a correction coefficient determined based on the number of requests, and a distance between the start location of the target lane change start zone and a request location where the vehicle lane change has been requested by the driver, in which the target zone determining unit determines the next target lane change start zone based on the reference lane change start zone and the new correction value.

In this vehicle control device, relationship between the correction coefficient and the number of requests preferably has a first zone in which the correction coefficient increases as the number of requests increases, a second zone in which the correction coefficient increases more than the first zone as the number of requests increases, and a third zone in which the correction coefficient increases less than the second zone as the number of requests increases.

In this vehicle control device, the correction value calculating unit preferably does not does not calculate the new correction value when the vehicle lane change has been requested by the driver at a different location than the start location of the target lane change start zone, and at least a predetermined number of other vehicles have been detected traveling on the traveling lane or on the adjacent lane that is adjacent to the traveling lane within a predetermined range from the vehicle, based on surrounding environment information indicating the environment surrounding the vehicle.

According to another embodiment, a non-transitory storage medium storing a computer program for vehicle control is provided. The computer program for vehicle control causes a processor to execute a process and the process includes setting a reference lane change start zone on a traveling lane, which is to be a reference zone in which a vehicle starts to move between lanes by automatic control, when movement of the vehicle from the traveling lane in which the vehicle is traveling to an adjacent lane is scheduled; determining a target lane change start zone on the traveling lane, where the vehicle is to be controlled so that the vehicle starts to move between lanes by automatic control, based on the reference lane change start zone and a current correction value; counting a number of requests as a number of times a vehicle lane change has been requested by a driver at a different location than a start location of the target lane change start zone; and calculating a new correction value for the reference lane change start zone, based on a correction coefficient determined based on the number of requests, and a distance between the start location of the target lane change start zone and a request location where the vehicle lane change has been requested by the driver, in which the next target lane change start zone is determined based on the reference lane change start zone and the new correction value.

Yet another embodiment of the invention provides a method for controlling a vehicle carried out by a vehicle control device. The method for controlling a vehicle is carried out by a vehicle control device and includes setting a reference lane change start zone on a traveling lane, which is to be a reference zone in which a vehicle starts to move between lanes by automatic control, when movement of the vehicle from the traveling lane in which the vehicle is traveling to an adjacent lane is scheduled; determining a target lane change start zone on the traveling lane, where the vehicle is to be controlled so that the vehicle starts to move between lanes by automatic control, based on the reference lane change start zone and a current correction value; counting a number of requests as a number of times a vehicle lane change has been requested by a driver at a different location than a start location of the target lane change start zone; and calculating a new correction value for the reference lane change start zone, based on a correction coefficient determined based on the number of requests, and a distance between the start location of the target lane change start zone and a request location where the vehicle lane change has been requested by the driver, in which the next target lane change start zone is determined based on the reference lane change start zone and the new correction value.

The vehicle control device of the present disclosure can set lane change start zones in a manner that allows lane changes to be carried out while reflecting driver preference.

The object and advantages of the invention will be realized and attained by means of the elements and combinations particularly pointed out in the claims. It is to be understood that both the foregoing general description and the following detailed description are exemplary and explanatory and are not restrictive of the invention, as claimed

### BRIEF DESCRIPTION OF DRAWINGS

FIG. 1 is a diagram illustrating operation of the traveling lane planning device of the embodiment in overview.

FIG. 2 is a general schematic drawing of a vehicle in which a vehicle control system of the embodiment is mounted.

FIG. 3 is an example of an operation flow chart for target lane change start zone assessment processing by a drive planning device of the embodiment.

FIG. 4 is an example of an operation flow chart for correction value calculation processing by a drive planning device of the embodiment.

FIG. 5 is a diagram showing an example of the relationship between the correction coefficient and number of requests.

FIG. 6 is a diagram illustrating a lane change where the lane change start has been delayed.

FIG. 7 is a diagram illustrating the correction value calculation processing for a modified example.

### DESCRIPTION OF EMBODIMENTS

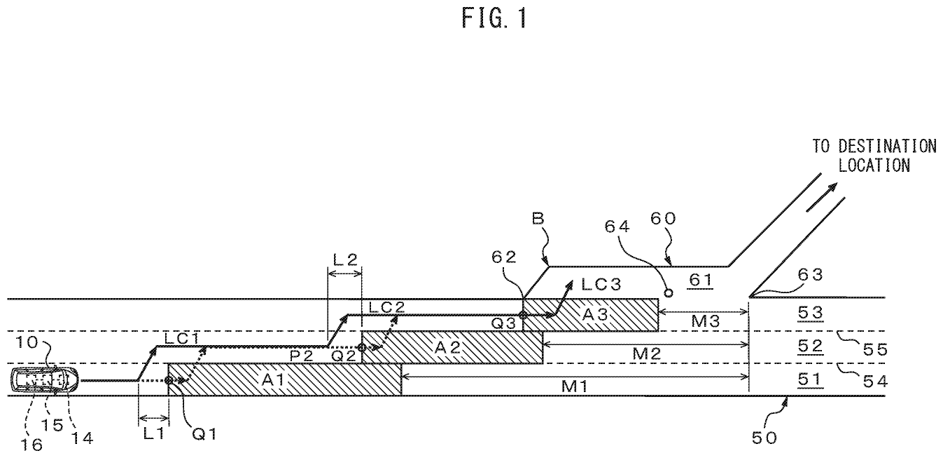

FIG. 1 is a diagram illustrating operation of the traveling lane planning device 14 of the embodiment. Operation relating to vehicle control processing by the traveling lane planning device 14 disclosed herein will now be described in overview with reference to FIG. 1. The traveling lane planning device 14 is an example of a vehicle control device.

The vehicle 10 has a traveling lane planning device 14, a drive planning device 15 and a vehicle control device 16. Specifically, the traveling lane planning device 14 selects a lane within the road on which the vehicle 10 is traveling, in the nearest driving zone selected from the navigation route, and creates a traveling lane plan representing a scheduled traveling lane on which the vehicle 10 is to travel.

The drive planning device 15 generates a driving plan representing a scheduled traveling trajectory for the vehicle 10 until a predetermined time, based on the traveling lane plan. The driving plan is represented as a combination of the target location of the vehicle 10 and the target vehicle speed at the target location, at each time from the current time until the predetermined time. The vehicle control device 16 controls operation of the vehicle 10 based on the driving plan. The vehicle 10 may be an autonomous vehicle.

FIG. 1 shows an example of a traveling lane plan created by a traveling lane planning device 14, for the most recent driving zone of a navigation route for the vehicle 10. The vehicle 10 is traveling on a road 50 and is scheduled to exit from a branching location B to a road 60 to proceed toward the destination location.

The road 50 has three lanes 51 to 53. The lane 51 and lane 52 are divided by a lane marking line 54, and the lane 52 and lane 53 are divided by a lane marking line 55. The traffic lane 53 of the road 50 and the lane 61 of the road 60 are connected between a branch start location 62 and a branch end location 63, at the branching location B.

The traveling lane plan indicates that three lane changes are to be carried out, followed by exit from the road 50 to the road 60. In the lane change plan of FIG. 1, target lane change start zones A1 to A3 are set for three lane changes LC1 to LC3 (broken lines) of the vehicle 10 from the current location, as a plan for movement to the lane 61 of the road 60.

The traveling lane planning device 14 first sets a reference lane change start zone on the lane 51, as the reference zone where movement of the vehicle 10 between lanes is to be started by automatic control. The traveling lane planning device 14 sets the reference lane change start zone on the lanes 51 to 53, based on the current location of the vehicle 10, the branching location B where the road 60 branches from the road 50, and the speed of the vehicle 10, for example.

The traveling lane planning device 14 also sets target lane change start zones A1 to A3 on the lanes 51 to 53, where the vehicle 10 is to be controlled to start movement between lanes by automatic control, based on the reference lane change start zone and the current correction value. The target lane change start zones A1 to A3 are zones where movement of the vehicle 10 from each traveling lane to its adjacent lane is scheduled to start by automatic control. The correction value is used to change the start location of the reference lane change start zone, setting the location where movement of the vehicle 10 between lanes is to start so that it can carry out the lane change in a manner reflecting driver preference.

When the drive planning device 15 detects a space that allows the vehicle 10 to move into the adjacent lane 52 after the vehicle 10 has entered the target lane change start zone A1, it generates a driving plan for movement from the lane 51 to the lane 52. The vehicle control device 16 causes the vehicle 10 to move from the lane 51 to the lane 52 based on the driving plan.

However, the driver of the vehicle 10, thinking to complete the lane change earlier, has requested for the vehicle 10 to make a lane change at a location before the start location Q1 of the target lane change start zone A1.

The vehicle 10 therefore carried out movement from the lane 51 to the lane 52 (solid line in LC1), at a location before the start location Q1 of the target lane change start zone A1, in response to a request for lane change by the driver.

After the vehicle 10 moved from the lane 51 to the lane 52, the driver of the vehicle 10 thought to complete the lane change earlier again, and thus requested a lane change at a location before the start location Q2 of the target lane change start zone A2.

The vehicle 10 therefore carried out movement from the lane 52 to the lane 53 (solid line in LC2) at a location before the start location Q2 of the target lane change start zone A2, in response to the request for lane change by the driver.

The vehicle 10 that moved from the lane 52 to the lane 53, after having entered the target lane change start zone A3, detected a space allowing the vehicle 10 to move into the lane 61 of the adjacent road 60, and moved from the lane 53 of the road 50 to the lane 61 of the road 60.

When a lane change for the vehicle 10 has been requested by the driver at a different location than the start location of the target lane change start zone, the traveling lane planning device 14 counts the number of times a lane change for the vehicle 10 has been requested by the driver.

The traveling lane planning device 14 also calculates a new correction value for the reference lane change start zone, based on the correction coefficient determined based on the number of requests, and the distance between the start location of the target lane change start zone and the request location where the lane change for the vehicle 10 has been requested by the driver (see L1 and L2 in FIG. 1). When the driver has requested a lane change at a location before the start location of the target lane change start zone, as in the example shown in FIG. 1, the correction value is calculated so that the start location of the next target lane change start zone is moved earlier.

When a lane change has been planned in the next driving zone selected from the navigation route, the traveling lane planning device 14 determines the next target lane change start zone based on the reference lane change start zone and the new correction value.

Since the traveling lane planning device 14 determines the target lane change start zone using the current correction value as explained above, the lane change start zone can be determined in a manner allowing the lane change to be made while reflecting driver preference. Operation of the traveling lane planning device 14 will now be explained later in greater detail with reference to FIG. 1.

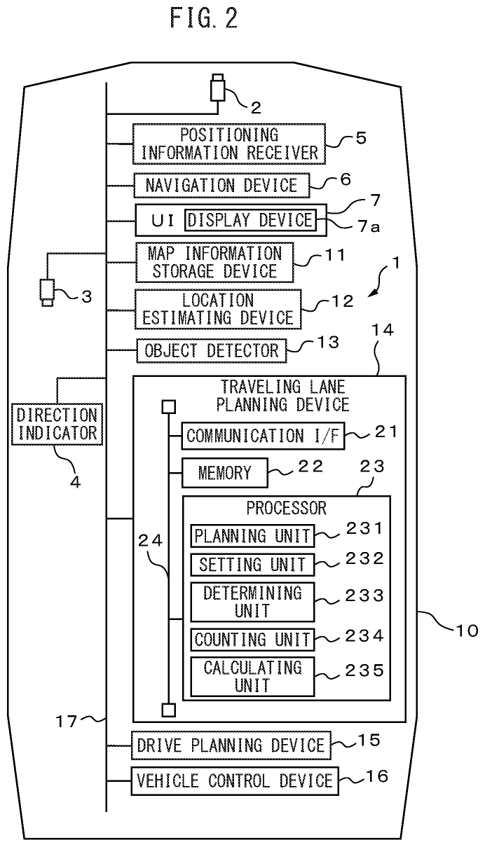

FIG. 2 is a general schematic drawing of a vehicle 10 in which a vehicle control system 1 of the embodiment is mounted. The vehicle 10 has, for example, a front camera 2, a monitoring camera 3, a direction indicator 4, a positioning information receiver 5, a navigation device 6, a user interface (UI) 7, a map information storage device 11, a location estimating device 12, an object detector 13, a traveling lane planning device 14, a drive planning device 15 and a vehicle control device 16, etc. The vehicle 10 may also have a millimeter wave radar, as a distance sensor (not shown) for measurement of the distance of the vehicle 10 to surrounding objects. The system 1 has at least the traveling lane planning device 14.

The front camera 2, monitoring camera 3, direction indicator 4, positioning information receiver 5, navigation device 6, UI 7, map information storage device 11, location estimating device 12, object detector 13, traveling lane planning device 14, drive planning device 15 and vehicle control device 16 are connected in a communicable manner through an in-vehicle network 17 that conforms to controller area network standards.

The front camera 2 is an example of an imaging unit provided in the vehicle 10. The front camera 2 is mounted inside the vehicle 10 and directed toward the front of the vehicle 10. The front camera 2, for example, takes a camera image in which the environment of a predetermined region ahead of the vehicle 10 is shown, at a predetermined cycle. The camera image can show the road in the predetermined region ahead of the vehicle 10, and road features such as surface lane marking lines on the road. The front camera 2 has a 2D detector composed of an array of photoelectric conversion elements with visible light sensitivity, such as a CCD or C-MOS, and an imaging optical system that forms an image of the photographed region on the 2D detector.

Each time a camera image is taken, the front camera 2 outputs the camera image and the camera image photograph time at which the camera image was taken, through the in-vehicle network 17 to the location estimating device 12 and object detector 13, etc. The camera image is also used for processing at the location estimating device 12 to estimate the location of the vehicle 10. At the object detector 13, the camera image is used for processing to detect other objects surrounding the vehicle 10.

The monitoring camera 3 is disposed in the vehicle compartment in a manner allowing it to take monitor images including the face of the driver driving the vehicle 10. The monitoring camera 3 is an example of a photographing device that takes monitor images including the face of the driver. The monitoring camera 3 may also be disposed on the steering column, room mirror, meter panel or meter hood, for example.

The monitoring camera 3 takes monitor images of the area near the driving seat in a predetermined cycle, for example. The monitoring camera 3 has a 2D detector composed of an array of photoelectric conversion elements with infrared sensitivity, such as a CCD or C-MOS, and an imaging optical system that forms an image of the photographed region on the 2D detector. Each time a monitor image is taken, the monitoring camera 3 outputs the monitor image and the monitor imaging time at which the monitor image was taken, to the vehicle control device 16, etc. via the in-vehicle network 18.

The direction indicator 4 is disposed near the steering wheel to allow its operation by the driver. When the vehicle 10 is being driven primarily by the vehicle control system 1, the driver requesting movement of the vehicle 10 between lanes operates the direction indicator 4 toward the lane to which movement of the vehicle 10 is desired. The direction indicator 4 generates an operation signal that corresponds to operation by the driver. The direction indicator 4 outputs the operation signal to the traveling lane planning device 14, etc. via the in-vehicle network 17. When the vehicle 10 is being driven primarily by the driver, the driver operates the direction indicator 4 toward the side to which the vehicle 10 is to be moved, for movement of the vehicle 10 to the left, right or between lanes. A directional indicator lamp (not shown) flashes based on the operation signal output by the direction indicator 4.

The positioning information receiver 5 outputs positioning information that represents the current location of the vehicle 10. The positioning information receiver 5 may be a GNSS receiver, for example. The positioning information receiver 5 outputs positioning information and the positioning information acquisition time at which the positioning information has been acquired, to the navigation device 6 and map information storage device 11, etc., each time positioning information is acquired at a predetermined receiving cycle.

Based on the navigation map information, the destination location of the vehicle 10 input through the UI 7, and positioning information representing the current location of the vehicle 10 input from the positioning information receiver 5, the navigation device 6 creates a navigation route from the current location to the destination location of the vehicle 10. The navigation route includes information relating to the locations of right turns, left turns, merging and branching. When the destination location has been newly set or the current location of the vehicle 10 has exited the navigation route, the navigation device 6 creates a new navigation route for the vehicle 10. Every time a navigation route is created, the navigation device 6 outputs the navigation route to the location estimating device 12 and the traveling lane planning device 14, etc., via the in-vehicle network 17.

The UI 7 is an example of the notification unit. The UI 7, controlled by the navigation device 6, drive planning device 15 and vehicle control device 16, etc., notifies the driver of the vehicle 10 traveling information. The traveling information of the vehicle 10 includes information relating to the current location of the vehicle, executing of lane changes, and the current and future route of the vehicle, such as the navigation route. The UI 7 has a display device 7a such as a liquid crystal display or touch panel, for display of the traveling information. The UI 7 may also have an acoustic output device (not shown) to notify the driver of traveling information. The UI 7 also generates an operation signal in response to operation of the vehicle 10 by the driver. The operation information may be, for example, a destination location, transit points, vehicle speed or other control information. The UI 7 also has a touch panel or operating button, for example, as an input device for inputting operation information from the driver to the vehicle 10. The UI 7 outputs the input operation information to the navigation device 6, the drive planning device 15 and the vehicle control device 16, etc., via the in-vehicle network 17.

The map information storage device 11 stores wide-area map information for a relatively wide area (an area of 10 to 30 km², for example) that includes the current location of the vehicle 10. The map information preferably has high precision map information including three-dimensional information for the road surface, the speed limit for the road, the curvature of the road, and information for the types and locations of structures and road features such as road lane marking lines.

The map information storage device 11 receives the wide-area map information from an external server via a base station, by wireless communication through a wireless communication device (not shown) mounted in the vehicle 10, in relation to the current location of the vehicle 10, and stores it in the storage device. Each time positioning information is input from the positioning information receiver 5, the map information storage device 11 refers to the stored wide-area map information and outputs map information for a relatively narrow area including the current location represented by the positioning information (for example, an area of 100 m² to 10 km²), through the in-vehicle network 17 to the location estimating device 12, object detector 13, traveling lane planning device 14, drive planning device 15 and vehicle control device 16, etc.

The location estimating device 12 estimates the location of the vehicle 10 at the camera image photograph time, based on the road features surrounding the vehicle 10 represented in the camera image taken by the front camera 2. For example, the location estimating device 12 compares lane marking lines identified in the camera image with lane marking lines represented in the map information input from the map information storage device 11, and determines the estimated location and estimated declination of the vehicle 10 at the camera image photograph time. The location estimating device 12 estimates the road traveling lane where the vehicle 10 is located, based on the lane marking lines represented in the map information and on the estimated location and estimated declination of the vehicle 10. Each time the estimated location, estimated declination and traveling lane of the vehicle 10 are determined at the camera image photograph time, the location estimating device 12 outputs this information to the object detector 13, traveling lane planning device 14, drive planning device 15 and vehicle control device 16, etc.

The object detector 13 detects other objects around the vehicle 10 and their types (for example, vehicles) based on the camera image. Other objects also include other vehicles traveling around the vehicle 10. The object detector 13 tracks other detected objects and determines the trajectories and speeds of the other objects. In addition, the object detector 13 identifies the traveling lanes in which the other objects are traveling, based on the lane marking lines represented in the map information and the locations of the objects. The object detector 19 also outputs object detection information which includes information representing the types of other objects that were detected, information indicating their locations and speeds, and also information indicating their traveling lanes, to the traveling lane planning device 14 and drive planning device 15, etc.

The traveling lane planning device 14 carries out plan processing, setting processing, assessment processing, count processing and calculation processing. The traveling lane planning device 14 has a communication interface (IF) 21, a memory 22 and a processor 23 for this purpose. The communication interface 21, memory 22 and processor 23 are connected via signal wires 24. The communication interface 21 has an interface circuit to connect the traveling lane planning device 14 with the in-vehicle network 17.

The memory 22 is an example of a memory unit, and it has a volatile semiconductor memory and a non-volatile semiconductor memory, for example. The memory 22 stores an application computer program and various data to be used for information processing carried out by the processor 23.

All or some of the functions of the traveling lane planning device 14 are functional modules driven by a computer program operating on the processor 23, for example. The processor 23 has a planning unit 231, a setting unit 232, a determining unit 233, a counting unit 234 and a calculating unit 235. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphic processing unit.

At a traveling lane-planning creation time set in a predetermined cycle, the planning unit 231 selects a traffic lane on the road on which the vehicle 10 is traveling, within the nearest driving zone (for example, 10 km) selected from the navigation route, based on the map information, the navigation route and surrounding environment information and the current location of the vehicle 10, and creates a traveling lane plan representing the scheduled traveling lane for traveling of the vehicle 10. The surrounding environment information includes the locations and speeds of other vehicles traveling around the vehicle 10. For example, the traveling lane planning device 14 creates a traveling lane plan for the vehicle 10 to travel on a traffic lane other than a passing traffic lane. Each time a traveling lane plan is created, the traveling lane planning device 14 outputs the traveling lane plan to the drive planning device 15. Other operations carried out by the traveling lane planning device 14 are described below.

At a driving plan creation time set with a predetermined cycle, the drive planning device 15 carries out driving plan processing in which it creates a driving plan representing the scheduled traveling trajectory of the vehicle 10 up until a predetermined time (for example, 5 seconds), based on the traveling lane plan, the map information, the current location of the vehicle 10, the surrounding environment information and the vehicle status information. The vehicle status information includes the current location of the vehicle 10, and the vehicle speed, acceleration and traveling direction. The driving plan is represented as a combination of the target location of the vehicle 10 and the target vehicle speed at the target location, at each time from the current time until the predetermined time. The cycle in which the driving plan is created is preferably shorter than the cycle in which the traveling lane plan is created. The drive planning device 15 generates a driving plan to maintain a spacing of at least a predetermined distance between the vehicle 10 and other objects (such as vehicles). The drive planning device 15 outputs the driving plan to the vehicle control device 16 for each driving plan generated.

The vehicle control device 16 controls each unit of the vehicle 10 based on the current location of the vehicle 10 and the vehicle speed and yaw rate, as well as on the driving plan generated by the drive planning device 15. For example, the vehicle control device 16 determines the steering angle, acceleration and angular acceleration of the vehicle 10 according to the driving plan and the speed and yaw rate of the vehicle 10, and sets the amount of steering, and the accelerator or brake level so as to match that steering angle, accelerator level and angular acceleration. The vehicle control device 16 also outputs a control signal corresponding to a set steering amount, to an actuator (not shown) that controls the steering wheel for the vehicle 10, via the in-vehicle network 17. The vehicle control device 16 also outputs a control signal corresponding to the set accelerator level, to a drive unit (engine or motor) of the engine of the vehicle 10, via the in-vehicle network 17. Alternatively, the vehicle control device 16 may output a control signal corresponding to a set brake level to the brake (not shown) of the vehicle 10, via the in-vehicle network 17.

The map information storage device 11, location estimating device 12, object detector 13, traveling lane planning device 14, drive planning device 15 and vehicle control device 16 are electronic control units (ECU), for example. For FIG. 2, the map information storage device 11, location estimating device 12, object detector 13, traveling lane planning device 14, drive planning device 15 and vehicle control device 16 were explained as separate devices, but all or some of them may be constructed in a single device.

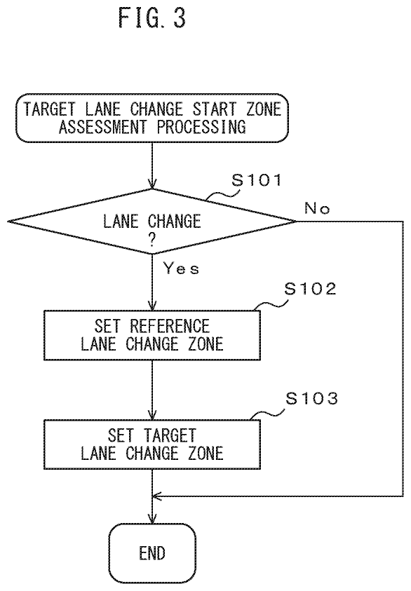

FIG. 3 is an example of an operation flow chart for target lane change start zone assessment processing by a traveling lane planning device 14 of the embodiment. Target lane change start zone assessment processing by the traveling lane planning device 14 will now be explained with reference to FIG. 3. The traveling lane planning device 14 carries out target lane change start zone assessment processing according to the operation flow chart shown in FIG. 3, at a target lane change start zone assessment time having a predetermined cycle. The cycle at which the target lane change start zone assessment processing is carried out is preferably no longer than the cycle for the driving plan creation time.

First, based on the traveling lane plan, the setting unit 232 determines whether or not a lane change is scheduled for movement of the vehicle 10 from the traveling lane in which it is traveling to an adjacent lane, in the nearest driving zone selected from the navigation route (step S101).

When a lane change is scheduled (step S101—Yes), the setting unit 232 sets a reference lane change start zone on the traveling lane, as the reference zone where movement of the vehicle 10 between lanes is to be started by automatic control (step S102). For example, the setting unit 232 sets the lane completion location where movement of the vehicle 60 on the adjacent lane is to be completed, and sets the reference lane change start zone on the traveling lane based on the lane completion location, the current location of the vehicle 10, and the speed of the vehicle 10. When two or more lane changes are planned, first the lane completion location is set on the lane where final movement of the vehicle is to be completed, and the reference lane change start zones are set on the respective lanes based on the lane completion location, the current location of the vehicle 10 and the speed of the vehicle 10.

The determining unit 233 then sets a target lane change start zone on the traveling lane, where the vehicle 10 is to be controlled to start movement between lanes by automatic control (step S103), based on the reference lane change start zone and the current correction value, and the series of processing steps is complete.

The determining unit 233 corrects the start location P of the reference lane change start zone (coordinates along the traveling direction of the vehicle 10) with the current correction value M, and calculates the start location of the target lane change start zone Q, according to the following formula (1).

Q=P+M (1)

Since the length of the target lane change start zone is the same as the length of the reference lane change start zone, the start location of the target lane change start zone changes from the reference lane change start zone only by the correction value M. When the correction value M is negative, the start location of the target lane change start zone P moves to a point before the start location Q of the reference lane change start zone. When the correction value M is positive, the start location of the target lane change start zone P moves to a point farther from the start location Q of the reference lane change start zone.

When no lane change is scheduled (step S101—No), the series of processing steps is complete. For the lane change carried out by the target lane change start zone assessment processing based on the traveling lane plan, the design may be such that the target lane change start zone assessment processing is not carried out until the vehicle 10 passes the lane completion location.

Operation whereby the traveling lane planning device 14 determines the target lane change start zone will now be explained with reference to FIG. 1.

As mentioned above, in the example shown in FIG. 1 the vehicle 10 is traveling on a road 50 and is scheduled to exit from a branching location B to a road 60 to proceed toward the destination location. In the lane change plan of FIG. 1, three lane changes LC1 to LC3 (broken lines) are planned from the current location.

The traveling lane planning device 14 sets a lane completion location 64 where movement of the vehicle 10 from the lane 53 of the road 50 onto the lane 61 of the road 60 is to be completed. The traveling lane planning device 14 then sets the reference lane change start zone on the lane 53, based on the lane completion location 64, the current location of the vehicle 10 and the speed of the vehicle 10. The length of the reference lane change start zone is the distance along the traveling direction of the vehicle 10. The length of the reference lane change start zone may be lengthened with a longer distance between the current location of the vehicle 10 and the lane completion location 64. The length of the reference lane change start zone may also be lengthened with a faster speed of the vehicle 10. When two or more lane changes are planned, the length of the reference lane change start zone may be longer closer to the traveling lane side. The length of each reference lane change start zone may also be the same.

The traveling lane planning device 14 also sets target lane change start zones A1 to A3 on the lanes 51 to 53, based on each reference lane change start zone and the current correction value. The correction values used to determine the target lane change start zones A1 to A3 are all the same.

The traveling lane planning device 14 also sets a manual operation lane change start zone M1 for the lane 51 to be between the target lane change start zone A1 and the branch end location 63. When a lane change of the vehicle 10 cannot be carried out by automatic control in one of the target lane change start zones A1 to A3, the vehicle control unit 16 notifies the driver via the UI 7 that a lane change is to be started manually. The driver moves the vehicle between lanes manually.

Likewise for the lane 52, the zone between the target lane change start zone A2 and the branch end location 63 is set as the manual operation lane change start zone M2, and for the lane 53, the zone between the target lane change start zone A3 and the branch end location 63 is set as the manual operation lane change start zone M3.

After the vehicle 10 has entered into the target lane change start zone, the vehicle control device 16 generates a driving plan for movement between lanes when it detects a space allowing the vehicle 10 to move into the destination lane. The vehicle control device 16 notifies the driver that a lane change is to be carried out and which lane is the destination lane, via the UI 7. When the driver has approved the lane change, the direction indicator 4 is operated to indicate the destination lane. When the driver has not approved the lane change, the direction indicator 4 is operated to indicate the opposite direction from the destination lane.

When the driver has approved the lane change, the vehicle control device 16 determines whether or not the face of the driver is directed toward the destination lane, based on a monitor image. When it has been determined that the face of the driver is directed toward the destination lane, the vehicle control device 16 carries out movement between lanes. When it has not been determined that the face of the driver is directed toward the destination lane, on the other hand, the vehicle control device 16 does not carry out movement between lanes.

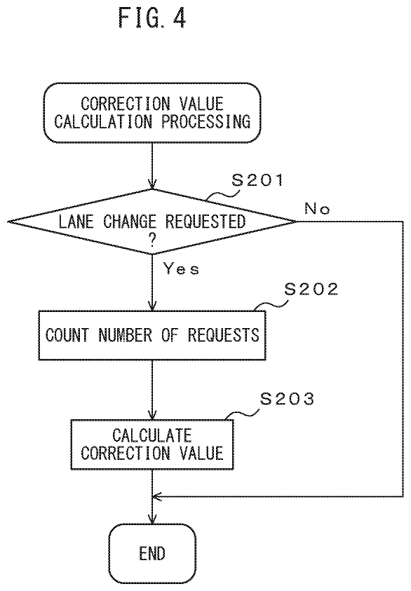

Correction value calculation processing will now be explained with reference to FIG. 4. FIG. 4 is an example of an operation flow chart for correction value calculation processing by the traveling lane planning device 14 of the embodiment. The traveling lane planning device 14 carries out correction value calculation processing according to the operation flow chart shown in FIG. 4, each time the vehicle 10 passes a target lane change start zone. As shown in FIG. 1, when a series of multiple target lane change start zones have been determined, correction value calculation processing may be carried out after the vehicle 10 has passed the target lane change start zones.

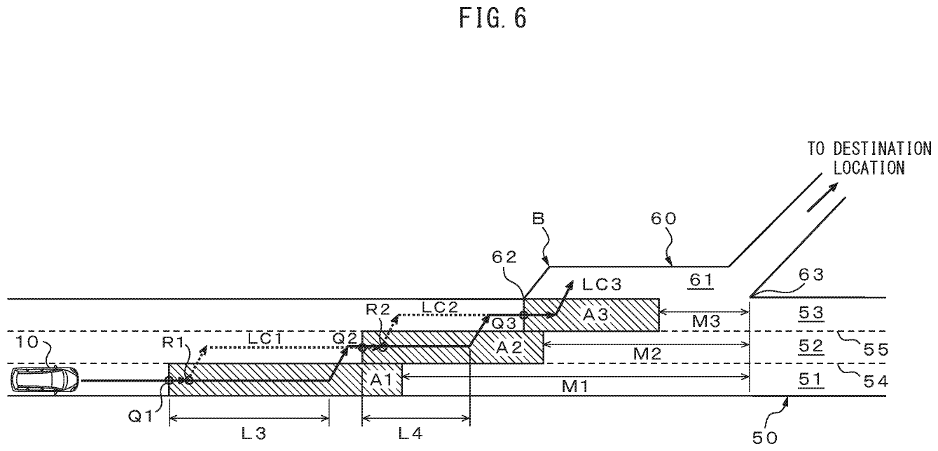

First, the counting unit 234 determines whether or not a lane change for the vehicle 10 has been requested by the driver at a different location than the start location of the target lane change start zone (step S201). When the distance between the start location of the target lane change start zone and the request location where the lane change for the vehicle 10 has been requested by the driver (L1 and L2 in FIGS. 1, L3 and L4 in FIG. 6) is at least a predetermined reference distance, the counting unit 234 determines that a lane change for the vehicle 10 has been requested by the driver at a different location than the start location of the target lane change start zone. The distance between the start location of the target lane change start zone and the request location where the lane change for the vehicle 10 has been requested by the driver is the distance along the traveling direction of the vehicle 10. The reference distance may also be a fixed reference value. Alternatively, the reference distance may be determined based on the speed of the vehicle 10. In this case the reference distance is determined so as to be longer with a faster speed of the vehicle 10.

When a lane change has been requested (step S201—Yes), the counting unit 234 counts the number of times a lane change for the vehicle 10 has been requested by the driver at a different location than the start location of the target lane change start zone (step S202). The initial value for the number of requests is zero.

The calculating unit 235 then calculates a new correction value for the reference lane change start zone, based on the correction coefficient determined based on the number of requests, and the distance between the start location of the target lane change start zone and the request location where the lane change for the vehicle 10 has been requested by the driver (step S203), and the series of processing steps is complete.

When a lane change has not been requested (step S201—No), the series of processing steps is complete.

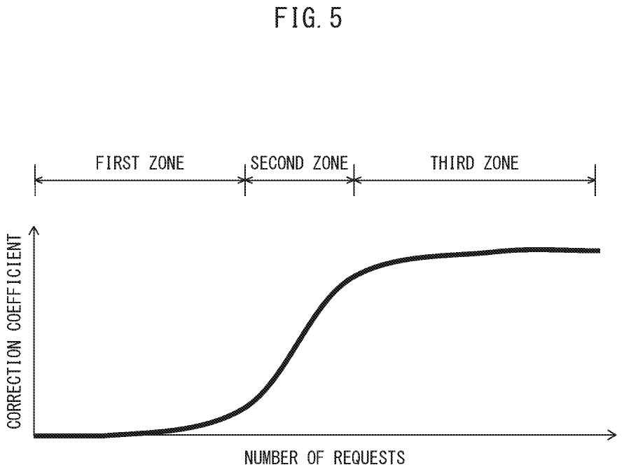

Processing in which the calculating unit 235 calculates a new correction value will now be explained with reference to FIG. 5. The calculating unit 235 calculates a new correction value as the product of the correction coefficient determined based on the number of requests, and the distance L between the start location of the target lane change start zone and the request location where the lane change for the vehicle 10 has been requested by the driver (L1 and L2 in FIGS. 1, L3 and L4 in FIG. 6).

FIG. 5 is a diagram showing an example of the relationship between the correction coefficient and number of requests. The relationship between the correction coefficient and number of requests has a first zone in which the correction coefficient increases as the number of requests increases, a second zone in which the correction coefficient increases more than the first zone as the number of requests increases, and a third zone in which the correction coefficient increases less than the second zone as the number of requests increases. In some cases, the request location by the driver at the early stage may be coincidental during the course of learning the correction values, and therefore the correction coefficient is low (first zone). When there is a tendency for the driver to the request location, the correction coefficient is high (second zone). However, the correction coefficient has an upper limit in practice (third zone). The correction coefficient used may be a sigmoid function, for example. For this embodiment, the correction coefficient is positive.

The product M (the correction value) of the correction coefficient and the distance L is calculated by the following formula (2). The variable “i” is the number of requests, “αᵢ” is the correction coefficient for the “i” th change, and Lᵢ is the distance for the “i” th change. The initial value α₀ of the correction coefficient may also be zero.

M=αᵢLᵢ (2)

When the start location of the target lane change start zone has changed to a closer point, the distance Li is negative and the correction coefficient αᵢ is zero or a positive value, and therefore the correction value M is zero or a negative value. When the start location of the target lane change start zone has changed to a further point, on the other hand, the distance Li is positive and the correction coefficient αᵢ is zero or a positive value, and therefore the correction value M is zero or a positive value. An upper limit is preferably set for the absolute value of the correction value M. The upper limit may be determined experimentally or empirically, for example.

An example of operation of the traveling lane planning device 14 when a lane change for the vehicle 10 has been requested by the driver at a location before the start location of the target lane change start zone will now be explained with reference to FIG. 1.

As mentioned above, the vehicle 10 is traveling on a road 50 and is scheduled to exit from a branching location B to a road 60 to proceed toward the destination location. In the lane change plan of FIG. 1, target lane change start zones A1 to A3 are set for three lane changes LC1 to LC3 (broken lines) from the current location, as a plan for movement to the lane 61 of the road 60.

When the drive planning device 15 detects a space allowing the vehicle 10 to move into the adjacent lane 52 after the vehicle 10 has entered the target lane change start zone A1 of the lane 51, it generates a driving plan for movement from the lane 51 to the lane 52. The vehicle control device 16 causes the vehicle 10 to move from the lane 51 to the lane 52 based on the driving plan.

However, the driver of the vehicle 10, thinking to complete the lane change earlier, has operated the direction indicator 4 and requested for the vehicle 10 to make a lane change at a location before the start location Q1 of the target lane change start zone A1.

The vehicle 10 therefore carried out movement from the lane 51 to the lane 52 (solid line in LC1), at a location before the start location Q1 of the target lane change start zone A1, in response to a request for lane change by the driver.

After the vehicle 10 moved from the lane 51 to the lane 52, the driver of the vehicle 10 thought to complete the lane change earlier again, and thus operated the direction indicator 4 to request a lane change at a location before the start location Q2 of the target lane change start zone A2.

The vehicle 10 therefore carried out movement from the lane 52 to the lane 53 (solid line in LC2), at a location before the start location Q2 of the target lane change start zone A2, in response to a request for lane change by the driver.

Next, after having entered the target lane change start zone A3 of the lane 53, the vehicle 10 detected a space allowing the vehicle 10 to move into the lane 61 of the adjacent road 60, and moved from the lane 53 of the road 50 to the lane 61 of the road 60.

The traveling lane planning device 14 carries out correction value calculation processing after the target lane change start zones for the three lane changes LC1 to LC3 have been passed.

Since a lane change has been requested by the driver at a location before the start location Q1 of the target lane change start zone A1 of the lane 51, the traveling lane planning device 14 counts the number of times a lane change for the vehicle 10 has been requested by the driver.

The traveling lane planning device 14 also calculates a new correction value for the reference lane change start zone, based on the correction coefficient determined based on the number of requests, and the distance L1 between the start location Q1 of the target lane change start zone A1 and the request location where the lane change for the vehicle 10 has been requested by the driver.

Moreover, since a lane change has been requested by the driver at a location before the start location Q2 of the target lane change start zone A2 of the lane 52, the traveling lane planning device 14 counts the number of times a lane change for the vehicle 10 has been requested by the driver.

The traveling lane planning device 14 also calculates a new correction value for the reference lane change start zone, based on the correction coefficient determined based on the number of requests, and the distance L2 between the start location Q2 of the target lane change start zone A2 and the request location where the lane change for the vehicle 10 has been requested by the driver. The traveling lane planning device 14 may also determine a new correction value for each of the lane changes LC1, LC2.

An example of operation of the traveling lane planning device 14 when a lane change for the vehicle 10 has been requested by the driver at a location after the start location of the target lane change start zone will now be explained with reference to FIG. 6. FIG. 6 is a diagram illustrating a lane change where the lane change start has been delayed. In the example shown in FIG. 6, a lane change plan is created in the same manner as FIG. 1.

When the drive planning device 15 detects a space allowing the vehicle 10 to move into the adjacent lane 52 after the vehicle 10 has entered the target lane change start zone A1 of the lane 51, it generates a driving plan for movement from the lane 51 to the lane 52. Based on the driving plan, the vehicle control device 16 notifies the driver that a lane change is to be carried out and which lane is the destination lane 52, via the UI 7. However, since the driver desired to arrive at the target lane earlier, the driver thought to travel on the current lane, which is the passing lane side. The driver operates the direction indicator 4 to indicate the opposite direction from the destination lane 52, and does not approve a lane change.

After the vehicle 10 has traveled for awhile in the target lane change start zone A1 of the lane 51, the driver operates the direction indicator 4 to the destination lane 52 side, for movement of the vehicle from the lane 51 to the lane 52.

The vehicle 10 therefore carried out movement from the lane 51 to the lane 52 (solid line in LC1), at a location after the start location Q1 of the target lane change start zone A1, in response to a request for lane change by the driver.

When the drive planning device 15 detects a space allowing the vehicle 10 to move into the adjacent lane 53 after the vehicle 10 has entered the target lane change start zone A2 of the lane 52, it generates a driving plan for movement from the lane 52 to the lane 53. Based on the driving plan, the vehicle control device 16 notifies the driver that a lane change is to be carried out and which lane is the destination lane 53, via the UI 7. However, since the driver again desired to arrive at the target lane earlier, the driver thought to travel on the current lane, which is the passing lane side. The driver operates the direction indicator 4 to indicate the opposite direction from the destination lane 52, and does not approve a lane change.

After the vehicle 10 has traveled for a while in the target lane change start zone A2 of the lane 52, the driver operates the direction indicator 4 to the destination lane 53 side, for movement of the vehicle from the lane 52 to the lane 53.

The vehicle 10 therefore carried out movement from the lane 52 to the lane 53 (solid line in LC2), at a location after the start location Q2 of the target lane change start zone A2, in response to a request for lane change by the driver.

Next, after having entered the target lane change start zone A3 of the lane 53, the vehicle 10 detected a space allowing the vehicle 10 to move into the lane 61 of the adjacent road 60, and moved from the lane 53 of the road 50 to the lane 61 of the road 60.

The traveling lane planning device 14 carries out correction value calculation processing after the target lane change start zones for the three lane changes LC1 to LC3 have been passed.

Since a lane change has been requested by the driver at a location after the start location Q1 of the target lane change start zone A1 of the lane 51, the traveling lane planning device 14 counts the number of times a lane change for the vehicle 10 has been requested by the driver.

The traveling lane planning device 14 also calculates a new correction value for the reference lane change start zone, based on the correction coefficient determined based on the number of requests, and the distance L3 between the start location Q1 of the target lane change start zone A1 and the request location where the lane change for the vehicle 10 has been requested by the driver. The start location of the target lane change start zone A1 may also be a location at which the vehicle control device 16 has notified the driver that a lane change is to be carried out and which lane is the destination lane 53. In this case, the distance L3 is the distance between a location R1 where the vehicle control device 16 has notified the driver that a lane change is to be carried out and which lane is the destination lane 52, and the request location where the lane change for the vehicle 10 has been requested by the driver.

Also since a lane change has been requested by the driver at a location after the start location Q2 of the target lane change start zone A2 of the lane 52, the traveling lane planning device 14 counts the number of times a lane change for the vehicle 10 has been requested by the driver.

The traveling lane planning device 14 also calculates a new correction value for the reference lane change start zone, based on the correction coefficient determined based on the number of requests, and the distance L4 between the start location Q2 of the target lane change start zone A2 and the request location where the lane change for the vehicle 10 has been requested by the driver.

When the driver has requested a lane change at a location after the start location of the target lane change start zone, as in the example shown in FIG. 6, the correction value is calculated so that the start location of the next target lane change start zone is moved later. The traveling lane planning device 14 may also determine a new correction value for each of the lane changes LC1, LC2.

Since the traveling lane planning device of the embodiment determines the target lane change start zone using the current correction value as explained above, the lane change start zone can be determined in a manner allowing the lane change to be made while reflecting driver preference.

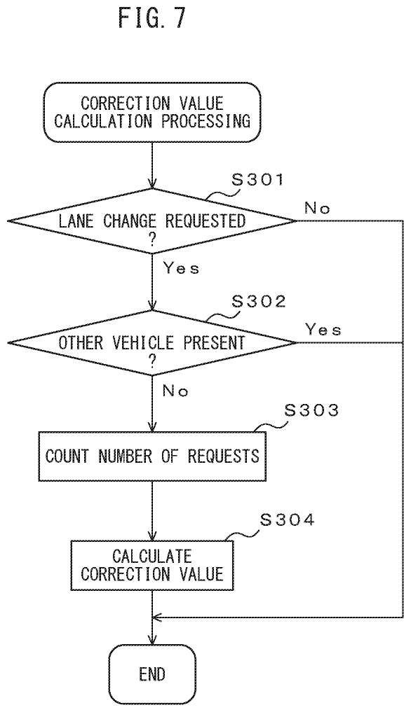

A modified operating example of the traveling lane planning device of the embodiment will now be further explained with reference to FIG. 7. FIG. 7 is a diagram illustrating correction value calculation processing for the modified example.

The correction value calculation processing shown in FIG. 7 differs from the correction value calculation processing shown in FIG. 4 in that the processing of step S302 has been added. The processing in steps S301, 303 and 304 is the same as the processing in steps S201 to 203.

In this modified example, when a lane change has been requested (step S301—Yes), it is determined whether or not at least a predetermined number of other vehicles have been detected traveling on the traveling lane or on an adjacent lane that is adjacent to the traveling lane within a predetermined range from the vehicle 10, based on surrounding environment information representing the environment surrounding the vehicle 10 (step S302).

When at least the predetermined number of other vehicles have not been detected (step S302—No), the counting unit 234 counts the number of times a lane change for the vehicle 10 has been requested by the driver at a different location than the start location of the target lane change start zone (step S303).

When at least the predetermined number of other vehicles have been detected, on the other hand (step S302—Yes), the series of processing steps is complete.

In this modified example, when there are at least a predetermined number of other vehicles surrounding the vehicle 10 (the traveling lane or adjacent lane), the driver may be confused and attempt to change lanes earlier than planned, or may be confused and attempt to change lanes later than planned. Therefore, a new correction value is not calculated when a lane change has been requested by the driver due to factors other than driver preference. This allows the correction value to be calculated while reflecting the lane change preference of the driver.

The vehicle control device, the computer program for vehicle control and the method for controlling a vehicle according to the embodiment described above may incorporate appropriate modifications that are still within the gist of the disclosure. Moreover, the technical scope of the disclosure is not limited to these embodiments, and includes the invention and its equivalents as laid out in the Claims.

For example, when the location where the vehicle is located is in bad weather with rain or snow, the correction coefficient may be zero or smaller, compared to when it is in a favorable weather location with sunny weather, for example. Since the road surface is wetted in bad weather, the vehicle driving conditions will differ from a weather situation with a dry road surface. This can lower the effect that correction in bad weather may have over the correction value in good weather. The correction value may also be determined separately for good weather and for bad weather.

1. A vehicle control device comprising:
a processor configured to
set a reference lane change start zone on a traveling lane, which is to be a reference zone in which a vehicle starts to move between lanes by automatic control, when movement of the vehicle from the traveling lane in which the vehicle is traveling to an adjacent lane is scheduled,
determine a target lane change start zone on the traveling lane, where the vehicle is to be controlled so that the vehicle starts to move between lanes by automatic control, based on the reference lane change start zone and a current correction value,
count a number of requests as a number of times a vehicle lane change has been requested by a driver at a different location than a start location of the target lane change start zone, and
calculate a new correction value for the reference lane change start zone, based on a correction coefficient determined based on the number of requests, and a distance between the start location of the target lane change start zone and a request location where the vehicle lane change has been requested by the driver,
wherein the next target lane change start zone is determined based on the reference lane change start zone and the new correction value.

2. The vehicle control device according to claim 1, wherein relationship between the correction coefficient and number of requests has a first zone in which the correction coefficient increases as the number of requests increases, a second zone in which the correction coefficient increases more than the first zone as the number of requests increases, and a third zone in which the correction coefficient increases less than the second zone as the number of requests increases.

3. The vehicle control device according to claim 1, wherein the processor is further configured to not calculate the new correction value when the vehicle lane change has been requested by the driver at a different location than the start location of the target lane change start zone, and at least a predetermined number of other vehicles have been detected traveling on the traveling lane or on the adjacent lane that is adjacent to the traveling lane within a predetermined range from the vehicle, based on surrounding environment information indicating the environment surrounding the vehicle.

4. A computer-readable, non-transitory storage medium storing a computer program for vehicle control, which causes a processor execute a process and the process comprising:
setting a reference lane change start zone on a traveling lane, which is to be a reference zone in which a vehicle starts to move between lanes by automatic control, when movement of the vehicle from the traveling lane in which the vehicle is traveling to an adjacent lane is scheduled;
determining a target lane change start zone on the traveling lane, where the vehicle is to be controlled so that the vehicle starts to move between lanes by automatic control, based on the reference lane change start zone and a current correction value;
counting a number of requests as a number of times a vehicle lane change has been requested by a driver at a different location than a start location of the target lane change start zone; and
calculating a new correction value for the reference lane change start zone, based on a correction coefficient determined based on the number of requests, and a distance between the start location of the target lane change start zone and a request location where the vehicle lane change has been requested by the driver,
wherein the next target lane change start zone is determined based on the reference lane change start zone and the new correction value.

5. A method for controlling a vehicle which is carried out by a vehicle control device and the method comprising:
setting a reference lane change start zone on a traveling lane, which is to be a reference zone in which a vehicle starts to move between lanes by automatic control, when movement of the vehicle from the traveling lane in which the vehicle is traveling to an adjacent lane is scheduled;
determining a target lane change start zone on the traveling lane, where the vehicle is to be controlled so that the vehicle starts to move between lanes by automatic control, based on the reference lane change start zone and a current correction value;
counting a number of requests as a number of times a vehicle lane change has been requested by a driver at a different location than a start location of the target lane change start zone; and
calculating a new correction value for the reference lane change start zone, based on a correction coefficient determined based on the number of requests, and a distance between the start location of the target lane change start zone and a request location where the vehicle lane change has been requested by the driver,
wherein the next target lane change start zone is determined based on the reference lane change start zone and the new correction value.
